(19) United States
(12) Patent Application Publication
(10) Pub. No.: US 2023/0087304 A1
(43) Pub. Date: Mar. 23, 2023

(54) SYSTEMS AND METHODS FOR REPORT DATA ANALYTICS

(71) Applicant: 41 ANALYTICS, INC., Indianapolis, IN (US)

(72) Inventors: Gabriel E. Reina, Tucson, AZ (US); Thomas R. Hershberger, Indianapolis, IN (US)

(21) Appl. No.: 17/799,220

(22) PCT Filed: Nov. 11, 2021
(86) PCT No.: PCT/US2021/058982

§ 371 Date: Aug. 11, 2022

Related U.S. Application Data
(60) Provisional application No. 63/113,501, filed on Nov. 13, 2020.

(51) Int. Cl. G06Q 10/063; G06N 20/00; G06Q 50/26

(52) U.S. Cl. CPC G06Q 10/063; G06N 20/00; G06Q 50/26

(57) ABSTRACT

Disclosed are systems and methods for report data analytics. In some embodiments, the method comprises: receiving a plurality of reports, each report of the plurality of reports comprising a data stream; receiving a plurality of records of interest and processing the plurality of reports using a plurality of analytics models to generate an analysis result for each report, the analysis result for each report indicative of finding the plurality of records of interest in a respective report. In some embodiments, at least one analytics model of the plurality of analytics models is configured to evaluate each report in a multidimensional analysis to generate a plurality of analytics scores, each analytics score of the plurality of analytics scores generated for a respective dimension.

### RELATED APPLICATIONS

The present application is based on and claims priority to U.S. Provisional Patent Application No. 63/113,501, filed on Nov. 13, 2020, the entire disclosure of which is expressly incorporated herein by reference.

### TECHNICAL FIELD

The present disclosure relates to data analytics in report data. Specifically, some embodiments of the present disclosure are related to data analytics in investigation report data.

### BACKGROUND

Numerous reports are generated, reviewed, and analyzed every day. Reports can include text and/or data streams. Some reports and report data are encrypted. Some reports are codified using various coding languages. For an investigation, a large number of reports, in text formats and various other formats, are reviewed and processed. An investigation report is a document or a data stream (e.g., text data stream, binary data stream, codified data stream, etc.) containing details of investigation findings, typically, documented by an investigator. For a lawsuit, a large amount of information and data, correctively referred to as report data, is retrieved and analyzed.

### SUMMARY

As recited in examples. Example 1 is a method implemented by a computer system having one or more processors and memories. The method comprises: receiving a plurality of reports, each report of the plurality of reports comprising a data stream receiving a plurality of records of interest; and processing the plurality of reports using a plurality of analytics models to generate an analysis result for each report, the analysis result for each report indicative of finding the plurality of records of interest in a respective report. In this Example, at least one analytics model of the plurality of analytics models is configured to evaluate each report in a multidimensional analysis to generate a plurality of analytics scores, each analytics score of the plurality of analytics scores generated for a respective dimension.

Example 2 is the method of Example 1, wherein the plurality of analytics scores comprise a percentage score indicative of matching to the plurality of records of interest in a respective report.

Example 3 is the method of Example 1 or 2, wherein the plurality of analytics scores comprise an attention score indicative of correlations of the plurality of records of interest in a respective report.

Example 4 is the method of any one of Examples 1-3, wherein the analysis result for a perspective report comprises a graphical representation of the multidimensional analysis.

Example 5 is the method of any one of Examples 1-4, wherein at least one analytics model of the plurality of analytics models is a rule-based model.

Example 6 is the method of any one of Examples 1-5, further comprising: decoding at least one report of the plurality of reports based on a coding language.

Example 7 is the method of any one of Examples 1-6 further comprising: decoding at least one report of the plurality of reports based on a coding language; and re-processing the at least one decoded report via the plurality of analytics models to generate an updated analysis result for the at least one report.

Example 8 is the method of any one of Examples 1-7, further comprising: decoding a first report of the plurality of reports based on a first coding language; and decoding a second report of the plurality of reports based on a second coding language, the second encoding language different from the first encoding language.

Example 9 is the method of any one of Examples 1-8, wherein the plurality of analytics models comprise a natural language processing model.

Example 10 is the method of any one of Examples 1-9, wherein the plurality of analytics models comprise a machine learning model, the machine learning model being trained by a plurality of historical report and associated analytics results.

Example 11 is the method of any one of Examples 1-10, further comprising:

receiving an input from a user.

Example 12 is the method of Example 11, wherein at least one of the plurality of analytics models comprises a rule, and wherein the rule is modified based on the input.

Example 13 is the method of Example 11, wherein the input comprises a format of data, wherein at least one of the plurality of analytics models comprises a rule related to a data format, and wherein the rule is modified based on the input.

Example 14 is the method of Example 11, wherein the input comprises information related to one or more coding languages.

Example 15 is the method of any one of Examples 1-14, wherein processing the plurality of reports comprises processing the plurality of reports using a plurality of logical layers, and wherein each logical layer of the plurality of logical layers is configured to apply one or more of the plurality of analytics models.

Example 16 is the method of 15, further comprising: receiving an input from a user; wherein the input comprises a configuration of the plurality of logical layers; wherein the configuration comprises at least one of an addition of a logical layer, a modification of a logical layer, a selection of a logical layer and a deselection of a logical layer.

Example 17 is the method of any one of Examples 1-16, further comprising: identifying one or more data units in a respective report using a set of selection criteria; wherein the set of selection criteria comprises at least one of a match criterion and a special data criterion; wherein the match criterion requires a match to a target record at a match level at or above a predetermined threshold; and wherein the special data criterion requires the data unit comprises special data.

Example 18 is the method of Example 17, wherein the match level is a number of characters matching the target record and a number of characters in the target record.

Example 19 is the method of Example 17, wherein the plurality of analytics scores comprise a percentage score indicative of a number of identified data units in a respective report.

Example 20 is the method of Example 17, wherein the plurality of analytics scores comprise an attention score indicative of identified data units in a respective report.

Example 21 is a computer-implemented system comprising one or more memories having instructions stored thereon; and one or more processors configured to execute the instructions to perform operations. The operations comprise: receiving a plurality of reports, each report of the plurality of reports comprising a data stream; receiving a plurality of records of interest; and processing the plurality of reports using a plurality of analytics models to generate an analysis result for each report, the analysis result for each report indicative of finding the plurality of records of interest in a respective report. In this Example, at least one analytics model of the plurality of analytics models is configured to evaluate each report in a multidimensional analysis to generate a plurality of analytics scores, each analytics score of the plurality of analytics scores generated for a respective dimension.

Example 22 is the system of Example 21, wherein the plurality of analytics scores comprise a percentage score indicative of matching to the plurality of records of interest in a respective report.

Example 23 is the system of Example 21 or 22, wherein the plurality of analytics scores comprise an attention score indicative of correlation of the plurality of records of interest in a respective report.

Example 24 is the system of any one of Examples 21-23, wherein the analysis result for a perspective report comprises a graphical representation of the multidimensional analysis.

Example 25 is the system of any one of Examples 21-24, wherein at least one analytics model of the plurality of analytics models is a rule-based model.

Example 26 is the system of any one of Examples 21-25, wherein the operations further comprise: decoding at least one report of the plurality of reports based on a coding language.

Example 27 is the system of any one of Examples 21-20, wherein the operations further comprise: decoding at least one report of the plurality of reports based on a coding language: and re-processing the at least one decoded report via the plurality of analytics models to generate an updated analysis result for the at least one report.

Example 28 is the system of any one of Examples 21-27 wherein the operations further comprise: decoding a first report of the plurality of reports based on a first coding language and decoding a second report of the plurality of reports based on a second coding language, the second encoding language di Brent from the first encoding language.

Example 29 is the system of any one of Examples 21-28, wherein the plurality of analytics models comprise a natural language processing model.

Example 30 is the system of any one of Examples 21-29, wherein the plurality of analytics models comprise a machine learning model, the machine learning model being trained by a plurality of historical report and associated analytics results.

Example 31 is the system of any one of Examples 21-30, wherein the operations further comprise: receiving an input from a user.

Example 32 is the system of Example 31, wherein at least one of the plurality of analytics models comprises a rule, and wherein the rule is modified based on the input.

Example 33 is the system of Example 31, wherein the input comprises a format of data, wherein at least one of the plurality of analytics models comprises a rule related to a data format, and wherein the rule is modified based on the input.

Example 34 is the system of Example 31, wherein the input comprises information related to one or more coding languages.

Example 35 is the system of any one of Examples 21-34, wherein processing the plurality of reports comprises processing the plurality of reports using a plurality of logical layers, and wherein each logical layer of the plurality of logical layers is configured to apply one or more of the plurality of analytics models.

Example 36 is the system of Example 35, wherein the operations further comprise: receiving an input from a user; wherein the input comprises a configuration of the plurality of logical layers; wherein the configuration comprises at least one of an addition of a logical layer, a modification of a logical layer, a selection of a logical layer and a deselection of a logical layer.

Example 37 is the system of any one of Examples 21-36, wherein the operations further comprise: identifying one or more data units in a respective report using a set of selection criteria; wherein the set of selection criteria comprises at least one of a match criterion and a special data criterion; wherein the match criterion requires a match to a target record at a match level at or above a predetermined threshold; and wherein the special data criterion requires the data unit comprises special data.

Example 38 is the system of Example 37, wherein the match level is a number of characters matching the target record and a number of characters in the target record.

Example 39 is the system of Example 37, wherein the plurality of analytics scores comprise a percentage score indicative of a number of identified data units in a respective report.

Example 40 is the system of Example 37, wherein the plurality of analytics scores comprise an attention score indicative of identified data units in a respective report.

### BRIEF DESCRIPTION OF DRAWINGS

The accompanying drawings are incorporated in and constitute a part of this specification and, together with the description, explain the features and principles of the present disclosure. In the drawings,

FIG. 1A depicts an illustrative system diagram of a report data analytics system, in accordance with certain embodiments of the present disclosure;

FIG. 1B depicts an illustrative block diagram of a report data analytics system, in accordance with certain embodiments of the present disclosure;

FIG. 2A depicts one illustrative flow diagram of a report data analytics system, in accordance with certain embodiments of the present disclosure;

FIG. 2B depicts another illustrative flow diagram of a report data analytics system, in accordance with certain embodiments of the present disclosure;

FIG. 3 depicts a photographic reproduction of illustrative examples of reports in various coding languages;

FIG. 4 depicts an illustrative example 400 of reports having records of interest;

FIG. 5A depicts one illustrative example of a graphical user interface for a report data analytics system; and

FIG. 5B depicts another illustrative example of a graphical user interface for a report data analytics system.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps, disclosed herein. However, certain some embodiments may require certain steps and/or certain orders between certain steps, as may be explicitly described herein and/or as may be understood from the nature of the steps themselves (e.g., the performance of some steps may depend on the outcome of a previous step). Additionally, a “set,” “subset,” or “group” of items (e.g., inputs, algorithms, data values, etc.) may include one or more items, and, similarly, a subset or subgroup of items may include one or more items. A “plurality” means more than one.

As used herein, the term “based on” or “based upon” is not meant to be restrictive, but rather indicates that a determination, identification, prediction, calculation, and/or the like, is performed by using, at least, the term following “based on” or “based upon” as an input. For example, predicting an outcome based on a particular piece of information may additionally, or alternatively, base the same determination on another piece of information.

For an incident, there are possibly a large number of related investigation reports to review and analyze. In some cases, two or more incidents are related. In some cases, investigation reports for different incidents are related. It has been difficult to identify correlations among investigation reports. As used herein, a report refers to a data stream retrieved or received from a data source, which can be a text data stream, a codified data stream, a numerical data stream, an alphanumerical data stream, a data record, a file, and/or the like. At least some embodiments of the present disclosure are directed to conducting data analytics to find correlations among reports of one incident or multiple incidents. Additionally, investigation reports tend to have various styles (e.g., abbreviation styles, term use styles, etc.) used by investigators and/or be in various coding languages (e.g., leetspeak coding, binary coding, etc.). At least some embodiments of the present disclosure are directed to conducting data analytics to account for the various styles and coding languages used in the investigation reports.

Some embodiments of the present disclosure describe a report data analytics system configured to evaluate report data in multidimensions and identify reports that have high evaluation scores in all or selected dimensions of the multidimensions. In some cases, the reports identified have high evaluation scores in all or selected dimensions of the multidimensions are more likely to be of interests to the user. In some cases, the report data analytics system can uncover hidden messages in the report data. Additionally, the system can help identify reports/records that the user should further investigate.

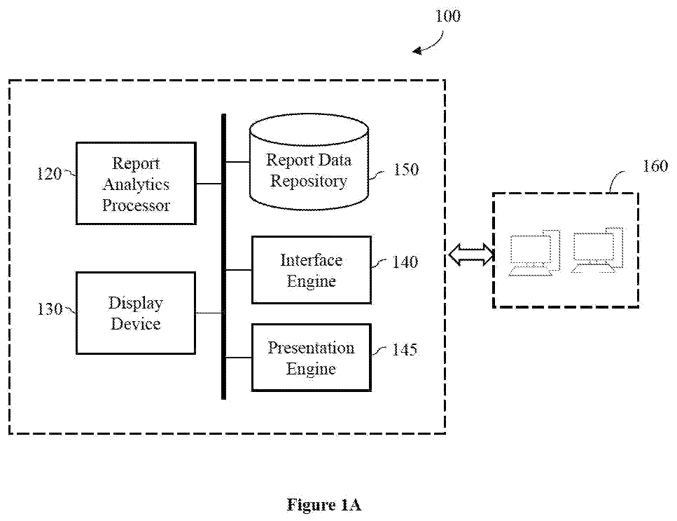

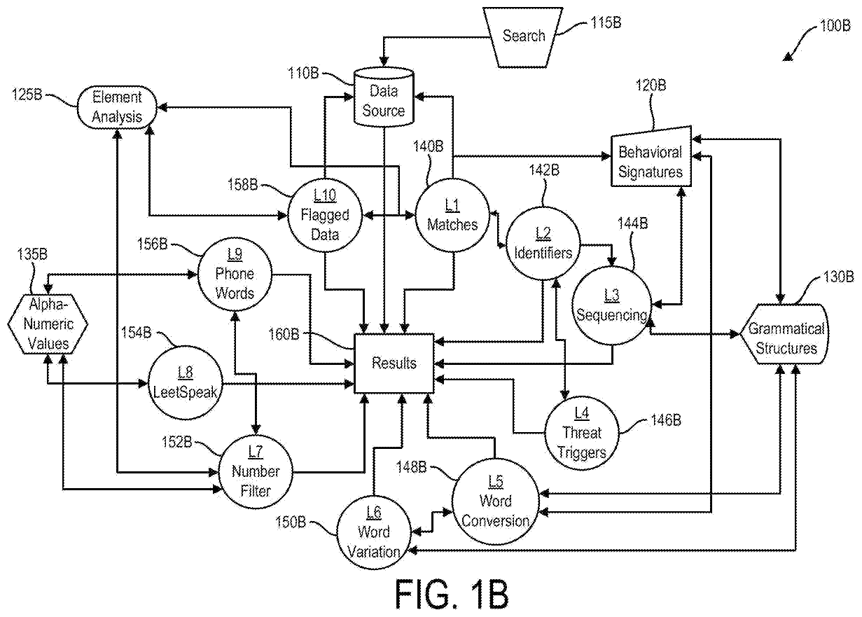

FIG. 1A depicts an illustrative system diagram of a report data analytics system 100, in accordance with certain embodiments of the present disclosure. As illustrated, the system 100 includes a report analytics processor 120, a display device 130, an interface engine 140, a presentation engine 145, and a report data repository 150. One or more components of the system 100 are optional. In some cases, the system 100 can include additional components. In some cases, the system 100 interfaces with one or more other systems 160, for example, an investigation system, a report repository, a user system, and/or the like.

In some embodiments, the report analytics processor 120 is configured to receive a plurality of reports. In some cases, the report analytics processor 120 may retrieve at least a part of the plurality of reports from the report data repository 150. In some cases, the report analytics processor 120 may receive at least a part of the plurality of reports from another system(s) 160 via the interface engine 140. In some cases, the plurality of reports are selected based on a report selection criteria, either manually or automatically. In one example, the report analytics processor 120 receives a pre-select report and selects one or more other reports based on the pre-select report, where the plurality of reports includes the pre-select report and the one or more other reports. In one example, the report analytics processor 120 identifies a plurality of records of interest in the pre-select report and selects one or more other reports based on a selection criteria. For example, the selection criteria is a selected report having content matching records of interest greater than a predetermined threshold (e.g., 60%).

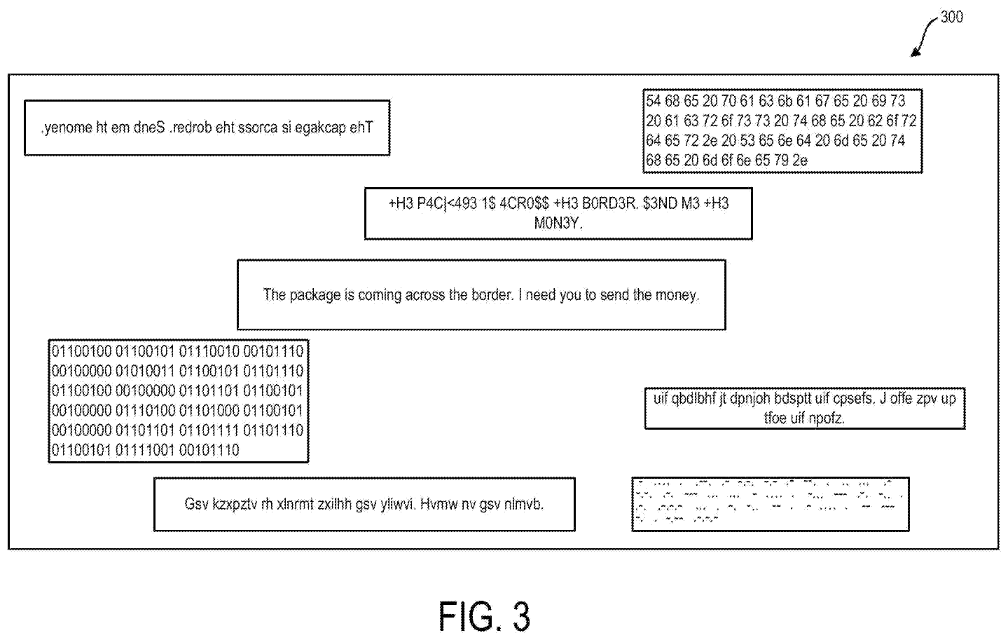

FIG. 3 depicts illustrative examples of reports 300 in various coding languages. In this example, each report of the reports 300 has same content but in different coding languages and/or languages. In some cases, the report analytics processor 120 may conduct some pre-processing of the reports. In some cases, the report analytics processor 120 is configured to implement and use a plurality of data analytics models to analyze the reports.

In some embodiments, the report analytics processor 120 is configured to decode one or more of the reports based on one or more coding languages. The coding languages can include, for example, backward coding language, Morse coding language, binary coding language, hexadecimal coding language, leetspeak coding language, hash coding language, shifted coding language, and/or the like. As used herein, coding languages includes encryption schemes (e.g., Advanced Encryption Standard encryption schemes, pseudo-random key encryption schemes, etc.) and spoken languages (e.g., English, Spanish, Chinese, etc.). In some cases, the report analytics processor 120 is configured to identify the coding language(s) used in a report and decode the report using the identified coding language(s).

In some embodiments, the report analytics processor 120 can detect or identify the coding language by, for example, identifying a known character and a corresponding code representing the character in the report. In some cases, the report analytics processor 120 is configured to identify the language (i.e., spoken language) used in a report and apply a corresponding translation of the identified language to the report. In some cases, the report analytics processor 120 is configured to determine or receive an encryption key to decrypt the report using the encryption key. In some cases, the report analytics processor 120 is configured to decode a first report of the plurality of reports based on a first coding language and decode a second report of the plurality of reports based on a second coding language, where the second coding language is different from the first coding language.

In some embodiments, the report analytics processor 120 is configured to use analytics models having natural language processing (“NLP”) functionalities, referred to as NLP models. In some cases, the report analytics processor 120 uses an NLP model to parse a report into n-grams and generate a plurality of terms based on the n-grams. As used herein, n-gram refers to a contiguous sequence of n words including numbers and symbols from a data stream, which typically is a phrase or a sequence of words with meaning. N-gram can include numbers and symbols, such as a comma, a period, a dollar sign, and/or the like. In some cases, the report analytics processor 120 normalizes the parsed n-grams. Further, in some cases, the report analytics processor 120 generates a plurality of normalized sections having normalized terms based on the n-grams. In one example, the plurality of intake terms include normalized n-grams. As one example, the n-grams is a date and the normalized term is the date in a predefined format (e.g., year-month-date). In some cases, the report analytics processor 120 uses an NLP model to determine contexts of the normalized terms. In one example, the contexts are a part of a same sentence of the normalized terms. In one example, the natural language processor 120 parses the n-grams and labels the n-grams based on the contexts, for example, period, expense, revenue, etc. In some embodiments, an NLP model can be a statistical language model, a neural network language model, and/or the like.

In some embodiments, the report analytics processor 120 is configured to receive a plurality of records of interest. In some cases, the plurality of records of interest include a set of predefined codes. For example, the set of predefined code may include trigger words, location of interest, name of interest, and/or the like. In some cases, the plurality of records of interest include a specific data format of interest, for example, a social security number, a date of birth, a driver license number of a region, a vehicle license number of a region, and/or the like. In some cases, the plurality of records of interest includes a set of predefined codes stored in the report data repository 150. In some cases, a user can configure the report data analytics system 100 by modifying the plurality of records of interest to include user-specified records of interest, select one or more records of interest, modify one or more records of interest, and/or deselect one or more records of interest. In some cases, the user can configure the plurality of records of interest via the interface engine 140. In some cases, a user can configure the plurality of records of interest via the presentation engine 145 and the display device 130 via manual inputs. In some cases, a user can configure the plurality of records of interest via another system 160 (e.g., a user system, a mobile application).

In some embodiments, the report analytics processor 120 is configured to evaluate whether a plurality of reports contain data units (e.g., words, numbers, phrases, alphanumerical sequences/value, etc.) matching one or more of the plurality of records of interest using one or more analytics model. In some cases, a match can be an exact match (i.e., a 100% match) or a threshold match (i.e., a match higher than a predetermined threshold) of data in comparison with a target record. In some cases, the match level is determined by character count. In one example, for a target record of “investigation,” a finding of the word “investigation” in a report is a match, and a finding of word “investigatin” is also a match for a threshold match with a threshold of 90%, while a finding of word “investigatn” is not a match for a threshold match with a threshold of 90%. In some embodiments, the report analytics processor 120 is configured to evaluate record matching before decoding the reports and after decoding the reports. In some embodiments, the report analytics processor 120 is configured to evaluate and/or label matches after decoding the reports.

In some cases, the report analytics processor 120 is configured to identify and/or label data units of interest in a respective report using a set of selection criteria. In some embodiments, the selection criteria includes at least one of a match criterion and a special data criterion. In some cases, the match criterion requires a match to a target record at or above a predetermined threshold, for example, an exact match or a threshold match. In some examples, the target record is one of records of interest. In some cases, the special data criterion requires the data unit comprises special data. In some cases, the special data includes, for example, identifiers, trigger words, words mixed with numbers, leetspeak terms, codified words, phone-words, and/or the like.

In some embodiments, the report analytics processor 120 is configured to process the plurality of reports via a plurality of analytics models to generate an analysis result for each report and/or each record of interest. In some cases, the report analytics processor 120 is configured to process the reports in a plurality of logical layers, where each logical layer may apply one or more analytics models. In some implementations, the analysis result is indicative of finding of the plurality of records of interest. In some cases, at least one analytics model of the plurality of analytics models is configured to evaluate each report in a multidimensional analysis to generate a plurality of analytics scores, each analytics score of the plurality of analytics scores generated for a respective dimension. In one embodiment, the analysis result includes the plurality of analytics scores.

In one embodiment, the report analytics processor 120 is configured to evaluate, each report in two dimensions, one is a percentage score and the other is an attention score. In some cases, the percentage score is indicative of matching to the plurality of records of interest in a respective report. In some cases, the attention score is indicative of correlation of the plurality of records of interest in a respective report. In some cases, the percentage score is indicative of the number of identified data units of interest in a respective report. In some cases, the attention score is indicative of identified data units in a respective report.

In some embodiments, the analytics models include rule-based analytics models. In some cases, a rule-based analytics model includes one or more rules for a selection criterion. In some cases, a rule-based analytics model includes one or more rules for a match criterion. In some cases, a rule-based analytics model includes one or more rules for a special data criterion. In some embodiments, the presentation engine 145 can generate a representation of rules included in the rule-based models and receive inputs from users to customize rules used in the report analytics system 100. For example, the use inputs can include addition of one or more user-specified rules, selection of one or more rules, modification of one or more rules, deselection of one or more rules, and/or the like. In some embodiments, a rule is represented in a rule data structure including parameters of the rule.

In some cases, the rule-based analytics model is configured to determine a plurality of analytics scores for a respective report based on the identified data units of interest. In one embodiment, the rule-based models include models to evaluate reports in two dimensions, one is a percentage score and the other is an attention score. In some embodiments, the rule-based models include model to evaluate reports in three dimensions—a threshold percentage score, a content percentage score, and an attention score. In some cases, an analytics model, also referred to as a percentage score model, is configured to determine a threshold percentage score based on the number of characters in the data units of interest identified in the report. In one example, the model is configured to take the number of character count in the identified data units of interest and divides it by the total number of characters available in the report data and multiplies it by 100 to yield the threshold percentage score.

In some cases, an analytics model (e.g., the percentage score model) is configured to determine a content percentage score based on the number of characters in the data units of interest identified via exactly matching to records of interest. In one example, the model is configured to take the number of character count in the identified matching data units and divides it by the total number of characters available in the report data and multiplies it by 100 to yield the content percentage score. In some embodiments, the percentage score is the threshold percentage score, the content percentage score, and/or a combination thereof.

In some embodiments, analytics model, also referred to as an attention score model, is configured to determine an attention score by assigning each identified data unit of interest with a point value. In one example, a data unit of interest that has a match to a record of interest at a level at or above a predetermined threshold (e.g., 90%, 100%) is assigned to a first point value (e.g., 2 points). In one example, a data unit of interest that has a match to a record of interest at a level between a user defined threshold (e.g., 60%, 70%) and less than the predetermined threshold is assigned to a second point value (e.g., 1 point).

In some cases, the attention score model is configured to assign an attention score to a report based on a summation of the point values assigned to data units of interest in the report. For example, if a report has 3 identified data units of interest with each assigned a point value of 2, the report is assigned to an attention score of 6. In some cases, the model is configured to assign an overall attention score to a report based on a normalized summation of the point values assigned to data units of interest in the report, where the normalized summation is based on a high attention score (e.g., 10, 100, etc.) and a low attention score that is smaller than the high attention score. In one example, a report is assigned to the high attention score if its point value total is the highest values across the plurality of reports. In one example, a report is assigned to the low attention score if its point value total is the lowest values across the plurality of reports. In one example, a report is assigned to an attention score between the high attention score and the low attention score that is proportional to its point value total from the lowest values across the plurality of reports.

In some embodiments, the analytics models include a filtering model to generate a subset of pertinent reports. In one embodiment, each report in the subset of pertinent reports has an analytics score higher than a predetermined score threshold in each dimension (e.g., percentage score higher than 50%, attention score higher than 5, etc.). In another embodiment, each report in the subset of pertinent reports has an analytics score higher than a predetermined score threshold in some selected dimensions.

In some embodiments, the analytics models include one or more machine learning models to identify/label data units of interest in reports and/or generate analytics results. The machine learning model may include any suitable machine learning models, deep learning models, and/or the like. In some cases, the machine learning model includes at least one of a decision tree, a random forest, a support vector machine, a neural network, a convolutional neural network, a recurrent neural network, and/or the like. In some embodiments, the report analytics processor 120 is configured to train a machine learning model using a plurality of reports (historical reports and/or currently processed reports), associated analytics results, and/or user configurations (e.g., coding language, selected logical layer, etc.) to generate a trained machine learning model. In some cases, the report analytics processor 120 can use the trained machine learning model to select a subset of reports for further analysis. In some cases, the report analytics processor 120 can use the trained machine learning model to scan the plurality of reports and predict data units of interest in the report.

In some embodiments, the report data analytics system 100 receives a plurality of historical reports, associated analytics results and/or user configuration for training and/or testing. In some cases, the report data analytics system 100 receives at least a part of the plurality of historical reports, associated analytics results and/or user configuration for training and/or testing from the report data repository 150. In some cases, the report data analytics system 100 receives at least a part of the plurality of historical reports, associated analytics results and/or user configuration for training and/or testing from another system 160, for example, via a software interface.

In some cases, the system may select a subset of reports, associated analytics results, and/or user configurations for training. In some cases, the subset of historical reports and associated analytics results are selected based on a taxonomy of the reports. In some cases, a subset of the reports and associated analytics results are used for testing (e.g., one third of the historical reports and associated analytics results). In some embodiments, the machine learning model comprises a neural network. In some cases, the neural network comprises a plurality of layers. In one embodiment, the neural network includes at least an input layer, one or more hidden layer, and an output layer. In some cases, the report analytics processor 120 can receive the historical reports and associated analytics results via retrieving the historical reports and associated analytics results from the report data repository 150. In some embodiments, the report analytics processor 120 is configured to predict one or more records of interest associated with a plurality of reports using the trained machine learning model.

In some cases, the report analytics processor 120 is configured to analyze a plurality of reports to generate a report percentage score indicative of a percent of reports containing a specific record of interest and select a subset of records of interest, where each record of interest in the subset has a report percentage score greater than a predetermined threshold (e.g., 60%). In some cases, the report analytics processor 120 is configured to analyze a report to generate a percentage score indicative of a percent of records of interest out of a total number of selected records of interest found in the report. In some cases, the report analytics processor 120 is configured to analyze a report to generate a percentage sane indicative of a percent of character numbers in the identified records of interest out of a total number of characters of the report.

In some embodiments, the interface engine 140 is configured to interface with other systems 160. In some embodiments, the interface engine 140 is configured to connect to an electronic investigation system or a user system 160 via a software interface. In some cases, the interface engine 140 is configured to use a set of predetermined protocol through the software interface. In some cases, the software interface comprises at least one of an application programming interface and a web service interface.

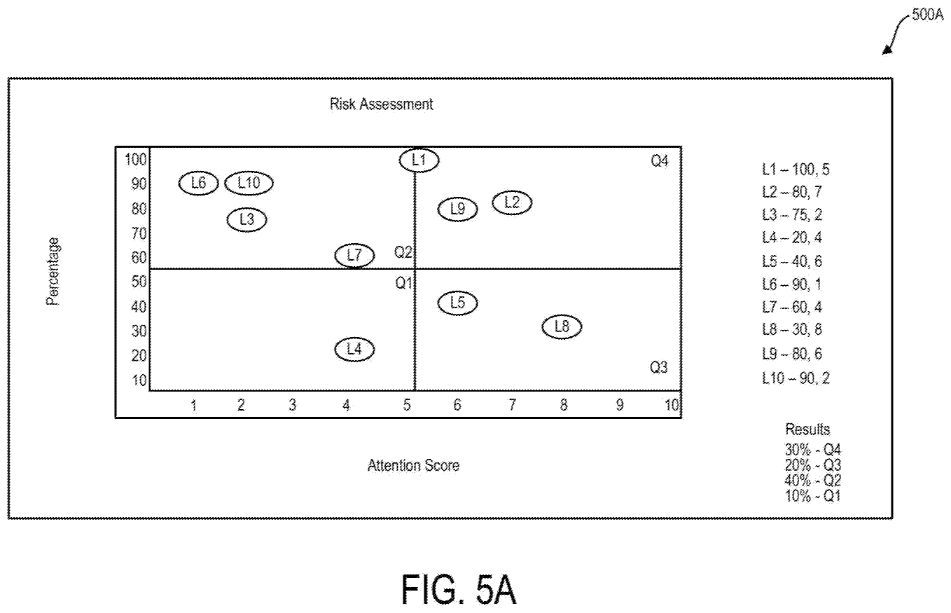

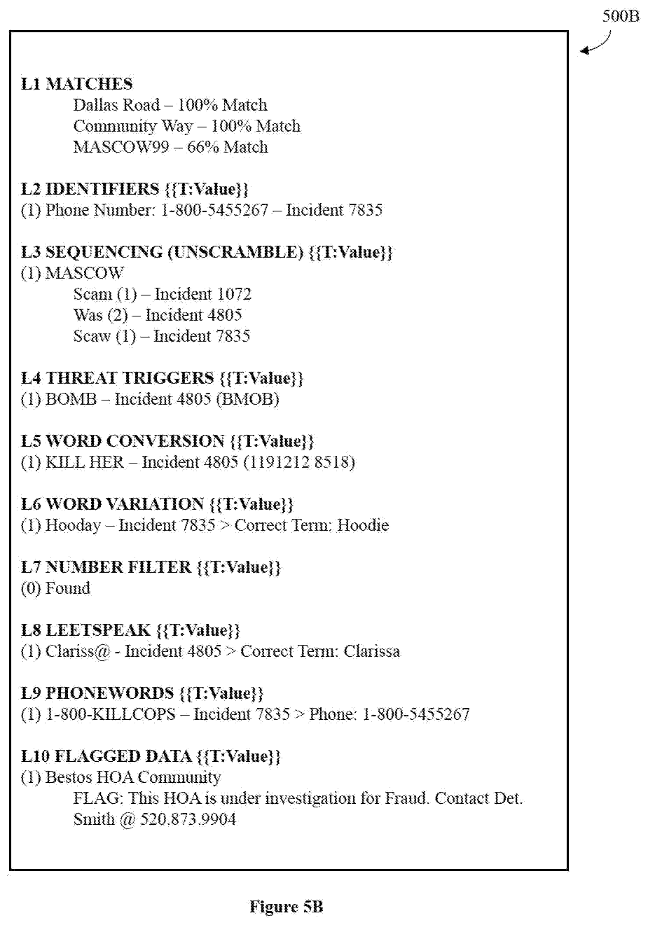

In some embodiments, the presentation engine 145 is configured to generate a representation of analytics results. FIG. 5A depicts one illustrative example of a graphical user interface for a report data analytics system. In this example, a graphical representation of the analytics result of a two-dimensional analytics scores for each logical layer is shown, where the two-dimensional analytics scores includes percentage scores and attention scores. In this example, each logical layer has a percentage score and an attention score. In some embodiments, the percentage score is indicative of an overall relevancy of the number of records of interest (e.g., character match) identified in the report. In some embodiments, the attention score is indicative of relevancy of records of interest (e.g., record match) identified in the report. Further in this example, analytics results in the Q4 (the 4^{th} quadrant) can be selected for further analysis and review, such that L2 and L9 layers should be evaluated and/or reviewed further. In some cases, this method is used to filter reports requesting additional review and analysis. In one example, the graphical representation depicts two-dimensional analytics scores of logical layers for one report. In one example, the graphical representation depicts aggregated two-dimensional analytics scores of logical layers for a plurality of reports. FIG. 5B depicts another illustrative example of a graphical user interface for a report data analytics system. In this example, the analytics results of each logical layer are included. In some cases, records of interest are highlighted in the analytics results.

In some embodiments, the presentation engine 145 is configured to receive an input from a user. In some cases, the report analytics processor 120 is configured to modify at least one analytics model of the plurality of analytics models based on the input. In some cases, the report analytics processor 120 is configured to modify one or more logical layers based on the input. In some cases, the input comprises a format of data. In some cases, the input comprises one or more coding languages.

In some embodiments, the report data repository 150 can include records of interests, reports, analytics results, historical reports and associated analytics results, user inputs, user configurations, system configurations and/or the like. The report data repository 150 may be implemented using any one of the configurations described below. A data repository may include random access memories, flat files, XML files, and or one or more database management systems (DBMS) executing on one or more database servers or a data center. A database management system may be a relational (RDBMS), hierarchical (HDBMS), multidimensional (MDBMS), object oriented (ODBMS or OODBMS) or object relational (ORDBMS) database management system, and the like. The data repository may be, for example, a single relational database. In some cases, the data repository may include a plurality of databases that can exchange and aggregate data by data integration process or software application. In an exemplary embodiment, at least part of the data repository may be hosted in a cloud data center. In some cases, a data repository may be hosted on a single computer, a server, a storage device, a cloud server, or the like. In some other cases, a data repository may be hosted on a series of networked computers, servers, or devices. In some cases, a data repository may be hosted on tiers of data storage devices including local, regional, and central.

In some cases, various components of the system 100 can execute software or firmware stored in non-transitory computer-readable medium to implement various processing steps. Various components and processors of the system 100 can be implemented by one or more computing devices, including but not limited to, circuits, a computer, a cloud-based processing unit, a processor, a processing unit, a microprocessor, a mobile computing device, and/or a tablet computer. In some cases, various components of the system 100 (e.g., the report analytics processor 120, the interface engine 140, the presentation engine 150) can be implemented on a shared computing device. Alternatively, a component of the system 100 can be implemented on multiple computing devices. In some implementations, various modules and components of the system 100 can be implemented as software, hardware, firmware, or a combination thereof. In some cases, various components of the report data analytics system 100 can be implemented in software or firmware executed by a computing device.

Various components of the system 100 can communicate via or be coupled to via a communication interface, for example, a wired or wireless interface. The communication interface includes, but not limited to, any wired or wireless short-range and long-range communication interfaces. The short-range communication interfaces may be, for example, local area network (LAN), interfaces conforming known communications standard, such as Bluetooth® standard, IEEE 802 standards (e.g., IEEE 802.11), a ZigBee® or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

FIG. 1B depicts an illustrative logical block diagram 100B of a report data analytics process, in accordance with certain embodiments of the present disclosure. As illustrated, the block diagram 100B includes a data source 110B, a search module 115B, a behavior signature module 120B, an element analysis module 125B, a grammatical structure module 130B, an alphanumeric values module 135B, a number of logic layers 140B-158B, and a results module 160B. One or more components of the block diagram 100B are optional. In some cases, the block diagram 100B can include additional components. In some embodiments, the data source can be implemented in a data repository (e.g., the report data repository 150 of FIG. 1A) and stores report data for, analysis. In some cases, one or more components and modules of the block diagram 100B can be performed, for example, by components of a report data analytics system (e.g., components of the report data analytics system 100 of FIG. 1A). In some cases, a component/module of the block diagram 100B is coupled to one or more other components/modules.

In some embodiments, the search module 115B can apply a number of search algorithms to the data source 110B. In some cases, the behavior signatures module 120B is configured to determine a behavior signature for a report generator (e.g., an investigator). A behavior signature includes, for example, grammatical structures, text patterns, word bank, word choices, emotional signature, and/or the like. In some embodiments, the element analysis module 125B is configured to analyze elements of interest in the report. In one example of investigation report analytics, the element analysis module 125B is configured to analyze drug information, drug ingredients, and/or the like. In some embodiments, the grammatical structure module 130B and the alphanumeric values module 135B can use a natural language processing model. In some embodiments, the grammatical structure module 130B is configured to analyze reports using grammars and sentence structures to identify behavior signatures. In some cases, the grammatical structure module 130B configured to use behavior signatures to extract information from report, for example, by changing the sequence of the letters in the report. The results module 160 can store analytics results from various modules and/or logical layers.

In some implementations, the alphanumeric values module 135B is configured to use an analytics model to evaluate alphanumeric values in a report and in some cases, replace the alphanumeric value (e.g., phone-words). In the example illustrated in FIG. 1B, the plurality of logical layers include a match-finding layer 140B, an identifier layer 142B, a sequencing layer 144B, a threat-trigger layer 146B, a word conversion layer 148B, a word variation layer 150B, a number filter layer 152B, a leetspeak layer 154B, a phone-words layer 156B, a flagged data layer 158B, and/or the like. In some embodiments, each of the logical layers 140B-158B is configured to use one or more analytics models. For example, a match-finding layer may use analytics model(s) in the behavior signatures module 120B to normalize the report data. In some cases, a user can configure the plurality of logical layers by, for example, selecting certain logical layers, adding one or more logical lavers, modifying one or more logic layers, and/or deselecting, one or more logical layers. Such user inputs/configurations can be stored in a data repository (e.g., the report data repository 150 of FIG. 1A). In the example illustrated, the logical layers can be interconnected, for example, an output of one logical layer is used as an input of another logical layer.

In some embodiments, the match-finding layer 140B is configured to evaluate a report related to records of interests, for example, how many records of interests are found in the report, what are the match level (e.g., 60%, 100%) of a match to a record of interest. The match-finding layer 140B can use any embodiments of analytics models described herein. In some embodiments, the match level can be determined using character count. In one embodiment, the match-finding layer 140B is configured to evaluate each report in two dimensions, one is a percentage score and the other is an attention score. In some embodiments, the match-finding layer 140B is configured to evaluate each report from three dimensions—a threshold percentage score, a content percentage score, and an attention score. In some cases, the match-finding layer 140B is configured to identify and/or label data units, each is an exact match or a threshold match to a record of interest, and to determine a threshold percentage score. In some cases, the match-finding layer 140B is configured to determine a threshold percentage score based on the number of characters in the identified data units of interest. In one example, the match-finding layer 140B is configured to take the number of character count in the identified data units of interest and divides it by the total number of characters available in the report data and multiplies it by 100 to yield the threshold percentage score.

In some embodiments, the match-finding layer 140B is configured to determine a content percentage score based on the number of characters in the identified data units that are exact matches to a respective record of interest, also referred to as matching data units. In one example, the match-finding layer 140B is configured to take the number of character count in the matching data units and divides it by the total number of characters available in the report data and multiplies it by 100 to yield the content percentage score. In some embodiments, the match-finding layer 140B is configured to determine an attention score by assigning each identified data unit of interest with a point value. In one example, each identified matching data unit in the report is assigned to a first point value (e.g., 2 points). Each identified data unit of interest that is not a matching data unit is assigned to a second point value (e.g., 1 point). In one example, if the report has two (2) matching data units of interest and one (1) other data unit of interest, the report is assigned with an attention score of 5. In another example, the match-finding layer 140B can evaluate across all reports or all selected reports to determine an overall attention score. In some cases, the match-finding layer 140B is configured to filter pertinent reports for the user using the evaluation in two or more dimensions. In one example, each pertinent report has a score higher than a respective predetermined threshold in each dimension of the two or more dimensions (e.g., the predetermined threshold for the percentage score dimension is 60%, the predetermined threshold for the attention score dimension is 5).

In some embodiments, the identifier layer 142B is configured to identify records in a report that match identifiers and/or label such identifiers, for example, using an identifier model. In some designs, the identifier model includes a set of identifier criteria. In some cases, the user can set the identifier criteria and/or parameters in the identifier criteria. In some cases, the identifier layer 142B is configured to store default identifier criteria in data repository (e.g., the report data repository 150 in FIG. 1A). One example of a default identifier is a data format for a social security number. One example of a user specified identifier is a data format for a driver license of a state. In one embodiment, an identifier can include various formats of the identifier. In the example of phone number identifier, the identifier can include a format of 10 digits (e.g., “xxxxxxxxxx”), with area code in parenthesis (e.g., “(xxx) xxx-xxxx”), and with dashes (e.g., “xxx-xxx-xxxx”), where each format can be set to an identifier criterion. In some embodiments, the identifier model is configured to identify and/or label identifiers (i.e., data units of interest) using the identifier criteria.

The identifier layer 142B can use any embodiments of analytics models described herein, In some embodiments, the identifier layer 142B is configured to evaluate a report in a multidimensional analysis to generate a plurality of analytics scores, each analytics score of the plurality of analytics scores generated for a respective dimension. In some cases, the identifier layer 142B is configured to analyze a report from two dimensions—a dimension of a percentage score and a dimension of an attention score. In some embodiments, the identifier layer 142B is configured to determine a percentage score based on the number of data units of interest identified in the report. in one embodiment, the identifier layer 142B is configured to determine a percentage score as the number of data units of interest identified in the report and is divided by the total number of words in the report multiplied by 100 to yield the percentage score.

In some embodiments, the identifier layer 142B is configured to determine an attention score by assigning each identified identifiers (i.e., data units of interest) in the report data with a point value (e.g., 1 point). In some embodiments, the report has an overall attention score assigned by the identifier layer 142B based on the number of identifiers identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the sequencing layer 144B is configured to process a report with unscrambled records of interest, e.g., each record of interest in various orders with selected alphanumeric values from the record of interest, using a sequencing model. In some cases, the order can be, for example, a reversed order, a random order, a circular shift, and/or the like. For example, a target record of “major” can have 2 unscrambled five-letter words, 2 unscrambled four-letter words, 12 unscrambled three letter words, and 7 unscrambled two-letter words. In some cases, the sequencing layer 144B is configured to create every possible combination of letters in a record of interest to generate words in various letter orders. It then compares word or data unit in a report with the unscrambled records of interest to evaluate if there are any matches or any threshold matches, including matches of a predetermined threshold or a user defined threshold (e.g., 90% match). In a match is found, the matched data unit is labelled/tagged as a data unit of interest.

In some embodiments, the sequencing layer 144B is configured to evaluate a report related to unscrambled records of interests, for example, to identify data units of interest, where each is a match (e.g., an exact match or a threshold match) to a respective unscrambled record of interest. The sequencing layer 144B can use any embodiments of analytics models described herein. In some embodiments, the sequencing layer 144B is configured to evaluate a report in a multidimensional analysis to generate a plurality of analytics scores, each analytics score of the plurality of analytics scores generated for a respective dimension. In some cases, the sequencing layer 144B is configured to analyze a report from two dimensions—a dimension of a percentage score and a dimension of an attention score. In some embodiments, the sequencing layer 144B is configured to determine a percentage score based on the number of data units of interest identified in the report. In one embodiment, the sequencing layer 144B is configured to determine a percentage score as the number of data units of interest identified in the report and is divided by the total number of words in the report multiplied by 100 to yield the percentage score.

In some embodiments, the sequencing layer 144B is configured to determine an attention score by assigning each identified unscrambled record of interest (i.e., data units of interest) in the report data with a point value (e.g., 1 point). In some embodiments, the report has an overall attention score assigned by the sequencing layer 144B based on the number of unscrambled records of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the threat-trigger layer 146B is configured to identify trigger words using a trigger word model. In some embodiments, the trigger words can be retrieved from a data repository (e.g., the report data repository 150 of FIG. 1A). In some embodiments, the trigger words can be added, modified, and/or selected by a user. One example of a trigger word is “shoot.”

In some cases, the threat-trigger layer 146B is configured to compare every word in a report with the trigger words to identify any matches or threshold matches. In some cases, the sequencing layer 146B is configured to compare every word in a report with the trigger words in various letter orders to identify any matches or threshold matches. In a match is found, the matched word is labelled as a data unit of interest. The threat-trigger layer 146B can use any embodiments of analytics models described herein.

In some embodiments, the threat-trigger layer 146B is configured to is configured to evaluate a report in a multidimensional analysis to generate a plurality of analytics scores, each analytics score of the plurality of analytics scores generated for a respective dimension. In some cases, the threat-trigger layer 146B configured to analyze a report from two dimensions—a dimension of a percentage score and a dimension of an attention score. In some embodiments, the threat-trigger layer 146B is configured to determine a percentage score based on the number of data units of interest identified in the report. In one embodiment, the threat-trigger layer 146B is configured to determine a percentage score as the number of data units of interest identified in the report and is divided by the total number of words in the report multiplied by 100 to yield the percentage score.

In some embodiments, the threat-trigger layer 146B is configured to determine an attention score by assigning each identified trigger words (i.e., data units of interest) in the report data with a point value (e.g., 1 point). In some embodiments, the report has an overall attention score assigned by the threat-trigger layer 146B based on the number of trigger words identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the word conversion layer 148B is configured to evaluate a report using a word conversion model. In some embodiment, the word conversion model is configured to generate converted records of interest by converting records of interest into numbers and/or alphanumerical values in various orders. In some cases, the order can be, for example, an unchanged order (e.g., direct conversion from letter to number), a reversed order, a random order, a circular shift, and/or the like. In one example, a record of interest “BOMB” has converted records of interest as “215132”, “231512”, “251312”, etc. In some cases, the mapping between alphabet and numbers can be configured/set by a user (e.g., by a user manually, by a system, etc.). In some cases, the word conversion layer 148B is configured to scan a report to identify an matches or threshold matches to the converted records of interest. In some cases, the word conversion layer 148B is configured to compare every data unit in a report with the word-converted records of interest to identify any matches or threshold matches. In a match is found, the matched data unit is labelled as a data unit of interest.

The word conversion layer 148B can use any embodiments of analytics models described herein. In some embodiments, the word conversion layer 148B is configured to evaluate a report in a multidimensional analysis to generate a plurality of analytics scores, each analytics score of the plurality of analytics scores generated for a respective dimension. In some cases, the word conversion layer 148B is configured to analyze a report from two dimensions—a dimension of a percentage score and a dimension of an attention score. In some embodiments, the word conversion layer 148B is configured to determine a percentage score based on the number of data units of interest identified in the report. In one embodiment, the word conversion layer 148B is configured to determine a percentage score as the number of data units of interest identified in the report and is divided by the total number of words in the report multiplied by 100 to yield the percentage score.

In some embodiments, the word conversion layer 148B is configured to determine an attention score by assigning each identified data unit of interest (i.e., data units of interest) in the report data with a point value (e.g., 1 point). In some embodiments, the report has an overall attention score assigned by the word conversion layer 148B based on the number of data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the word variation layer 150B is configured to evaluate a report using a word variation model to identify variations (e.g., a slang term) of records of interest, also referred to as variated records of interest. In one example, the word “because” has the variations of “cus”, “cuz”, and “be”. In some cases, the word-variation layer 150B is configured to scan a report to identify any matches or threshold matches to the variated records of interest. In some cases, the word variation layer 150B is configured to compare data units in a report with variated records of interest to identify any matches or threshold matches. In a match is found, the matched data unit is labelled/tagged as a data unit of interest.

The word variation layer 150B can use any embodiments of analytics models described herein. In some embodiments, the word variation layer 150B is configured to evaluate a report in a multidimensional analysis to generate a plurality of analytics scores, each analytics score of the plurality of analytics scores generated for a respective dimension. In some cases, the word variation layer 150B is configured to analyze a report from two dimensions—a dimension of a percentage score and a dimension of an attention score. In some embodiments, the word variation layer 150B is configured to determine a percentage score based on the number of data units of interest identified in the report. In one embodiment, the word variation layer 150B is configured to determine a percentage score as the number of data units of interest identified in the report and is divided by the total number of words in the report multiplied by 100 to yield the percentage score.

In some embodiments, the word variation layer 150B is configured to determine an attention score by assigning each identified data unit of interest (i.e., data units of interest) in the report data with a point value (e.g., 1 point). In some embodiments, the report has an overall attention score assigned by the word variation layer 150B based on the number of data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the number filter layer 152B is configured to evaluate a report by identifying data units having numbers mixed with alphanumeric characters in the reports, which is referred to as word-with-number, for example, using a numbering model. In some cases, the numbering model is configured to remove numbers between alphabetical characters. For example, a number filter is configured to covert “fil2ter” to “filter”. In some embodiments, the number filter layer 152B is configured to label each data unit in the report that is a word-with-number. In some embodiments, the number filter layer 152B is configured to evaluate a report related to the words-with-numbers in the report, for example, how many words-with-numbers are found in the report. In one embodiment, the number filter layer 152B is configured to evaluate each report in two dimensions, one is a percentage score and the other is an attention score.

In some embodiments, the number filter layer 152B is configured to determine a percentage score based on the number of removed numbers from the report. In some embodiments, the number filter layer 152B is configured to determine a percentage score based on the number of word-with-number data units identified in the report. In one embodiment, the number filter layer 152B is configured to determine a percentage score as the number of removed numbers from the report and is divided by the total number of characters in the report multiplied by 100 to yield the percentage.

In some embodiments, the number filter layer 152B is configured to determine an attention score by assigning each identified word-with number in the report data with a point value (e.g., 1 point). In some embodiments, the report has an overall attention score assigned by the number filter layer 152B based on the number of word-with-number identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the leetspeak layer 154B is configured to evaluate a report by identifying data units having leetspeaks in the reports, for example, using a leetspeak model. As one example, a leetspeak data unit (i.e., a data unit of interest) has the letter “a” replaced by the symbol “@”. As another example, a leetspeak data unit has the letter “e” replaced by the number “3”. In some embodiments, the leetspeak layer 244B is configured to identify and/or label leetspeak data units in the report. In some embodiments, the leetspeak layer 244B is configured to identify and/or label leetspeak data units that are matches or threshold matches to leetspeak-version records of interest in the report. In some cases, the leetspeak model is configured to covert the leetspeak data unit to a regular word. For example, a leetspeak model is configured to covert “filt3r” to “filter”. In some embodiments, the leetspeak layer 244B is configured to evaluate a report related to leetspeak words and/or leetspeak-version records of interest in the report, for example, how many leetspeak words are found in the report, how many leetspeak-version records of interest in the report. In one embodiment, the leetspeak layer 244B is configured to evaluate each report in two dimensions, one is a percentage score and the other is an attention score.

In some embodiments, the leetspeak layer 244B is configured to determine a percentage score based on the number of the identified leetspeak data units (e.g., data units having leetspeak or matching leetspeak-version records of interest) in the report. In some embodiments, the leetspeak layer 244B is configured to determine a percentage score based on the number of the identified leetspeak data units in the report. In one embodiment, the leetspeak layer 244B is configured to determine a percentage score as the number of identified leetspeak data units in the report and is divided by the total number of words in the report multiplied by 100 to yield the percentage score.

In some embodiments, the leetspeak layer 244B is configured to determine an attention score by assigning each identified leetspeak data units in the report data with a point value (e.g., 1 point). In some embodiments, the report has an overall attention score assigned by the leetspeak layer 244B based on the number of the identified leetspeak data units in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the phone-words layer 156B is configured to evaluate a report by identifying mnemonic phrases in the report, for example, by a phone-word model. In one example, a phone-word is a data unit replacing the number “2” by alphabetical letter “A”, “B”, or “C”. In some embodiments, the phone-words layer 246B is configured to identify and/or label data units as phone-word data units of interest in the report that are phone-words. In one embodiment, a phone-word is a data unit matching certain identifier format after replacing alphabetical characters with corresponding numbers. In some embodiments, the phone-words layer 246B is configured to identify and/or label data units as phone-word data units of interest in the report that are matches or threshold matches to phone-word-version records of interest. In some cases, the phone-words model is configured to covert the phone-words data unit to a regular identifier. For example, a phone-word model is configured to covert “1-800-ABC-DEFG” to “1-800-222-3334”. In some embodiments, the phone-words layer 246B is configured to evaluate a report related to the identified phone-word data units in the report, for example, how many phone-words phrases are found in the report, how many phone-words-version records of interest in the report. In one embodiment, the phone-words layer 246B is configured to evaluate each report in two dimensions, one is a percentage score and the other is an attention score.

In some embodiments, the phone-words layer 246B is configured to determine a percentage score based on the number of phone-word data units of interest identified in the report. In some embodiments, the phone-words layer 246B is configured to determine a percentage score based on the number of phone-word data units of interest identified in the report. In one embodiment, the phone-words layer 246B is configured to determine a percentage score as the number of phone-word data units of records of interest identified in the report and is divided by the total number of words in the report multiplied by 100 to yield the percentage score.

In some embodiments, the phone-words layer 246B is configured to determine an attention score by assigning each identified phone-word data units of interest in the report data with a point value (e.g., 1 point). In some embodiments, the report has an overall attention score assigned by the phone-words layer 246B based on the number of phone-word data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the flagged data layer 158B is configured to evaluate a report based on data flagged by a user. In some cases, the flagged data layer 158B is configured to label the flagged data. In some embodiments, the flagged data layer 158B is configured to evaluate a report related to the flagged data in the report, for example, how many flagged data are found in the report. In one embodiment, the flagged data layer 158B is configured to evaluate each report in two dimensions, one is a percentage score and the other is an attention score.

In some embodiments, the flagged data layer 158B is configured to determine a percentage score based on the number of flagged data identified in the report. In some embodiments, the flagged data layer 158B is configured to determine a percentage score based on the number of flagged data and/or the number of characters in the flagged data identified in the report. In one embodiment, the flagged data layer 158B is configured to determine a percentage score as the number of identified flagged data and is divided by the total number of words in the report multiplied by 100 to yield the percentage score. In one embodiment, the flagged data layer 158B is configured to determine a percentage score as the number of characters in identified flagged data and is divided by the total number of words in the report multiplied by 100 to yield the percentage score.

In some embodiments, the flagged data layer 158B is configured to determine an attention score by assigning each identified flagged data in the report data with a point value (e.g., 1 point). In some embodiments, the report has an overall attention score assigned by the flagged data layer 158B based on the number of flagged data identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

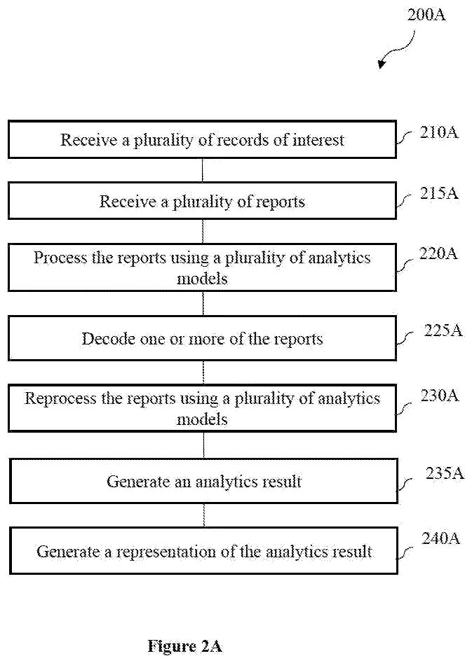

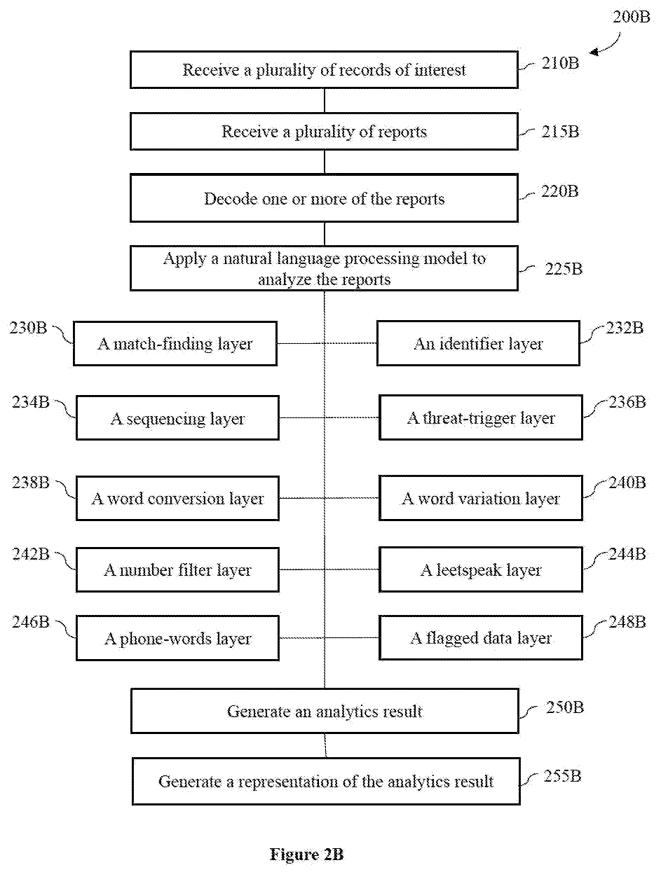

FIG. 2A depicts one illustrative flow diagram of a report data analytics system, in accordance with certain embodiments of the present disclosure. Aspects of embodiments of the method 200A may be performed, for example, by components of a report data analytics system (e.g., components of the report data analytics system 100 of FIG. 1A). One or more steps of method 200A are optional and/or can be modified by one or more steps of other embodiments described herein. Additionally one or more steps of other embodiments described herein may be added to the method 200A. In some embodiments, the report data analytics system receives a plurality of records of interest (210A).

In some embodiments, the plurality of records of interest is a set of predefined codes. In some cases, the plurality of records of interest include a specific data format of interest, for example, the social security number, the date of birth, a driver license number, a vehicle license number, and/or the like. In some cases, the plurality of records of interest is a set of predefined codes stored in a data repository (e.g., the report data repository 150 of FIG. 1A). In some eases, a user can modify the plurality of records of interest to add user-specified records of interest, select certain records of interest, modify certain records of interest, and/or deselect certain records of interest. In some cases, the user can configure the plurality of records of interest via a graphical user interface to the system. In some cases, the user can configure the plurality of records of interest via system setting. In some cases, a user can configure the plurality of records of interest with inputs received via a software interface (e.g., an application programming interface, a web service, etc.).

In some embodiments, the report data analytics system is configured to receive a plurality of reports (215A). In some cases, the plurality of reports are of a single incident. In some cases, the plurality of reports are of two or more incidents. In some cases, the plurality of reports are selected by one or more criteria, for example, incident location, incident time, and/or the like. In some cases, the report data analytics system may retrieve at least a part of the plurality of reports from a data repository. In some cases, the report data analytics system may receive at least a part of the plurality of reports from another system(s), for example, via a software interface. FIG. 3 depicts illustrative examples of reports 300 in various coding languages. In this example, each report of the reports 300 is of same content but in different coding languages.

In some embodiments, the report data analytics system is configured to decode to one or more of the reports (225A), for example, by decoding the one or more reports using one or more coding languages. The coding languages include, for example, backward coding language, Morse coding language, binary coding language, hexadecimal coding language, leetspeak coding language, hash coding language, shifted coding language, and/or the like. In some cases, the report data analytics system is configured to identify the coding language(s) used in a report and apply the identified coding language(s) to decode the report. In some cases, the report data analytics system is configured to identify the language used in a report and apply a corresponding translation of the identified language to the report. In some cases, the report data analytics system is configured to decode a first report of the plurality of reports based on a first coding language and decode a second report of the plurality of reports based on a second coding language, where the second coding language is different from the first coding language.

In some embodiments, the report data analytics system can apply a natural language processing model to analyze the reports. In some cases, the report data analytics system parses a report into n-grams and generate a plurality of terms based on the n-grams. As used herein, n-gram refers to a contiguous sequence of n words including numbers and symbols from a data stream, which typically is a phrase or a sequence of words with meaning. N-gram can include numbers and symbols, such as a comma, a period, a dollar sign, and/or the like. In some cases, the report data analytics system normalizes the parsed n-grams. Further, in some cases, the report data analytics system generates a plurality of normalized sections having normalized terms based on the n-grams. In one example, the plurality of intake terms include normalized n-grams. As one example, the n-grams is a date and the normalized term is the date in a predefined format (e.g., year-month-date). In some cases, the report data analytics system determines contexts of the normalized terms. In one example, the contexts are a part of a same sentence of the normalized terms. In one example, the natural language system parses the n-grams and labels the n-grams based on the contexts, for example, period, expense, revenue, etc. In some embodiments, a report data analytics system uses a natural language model for processing the document and parsed n-grams. For example, a natural language model can be a statistical language model, a neural network language model, and/or the like.

In some embodiments, the report data analytics system is configured to process the plurality of reports using a plurality of analytics models (220A) and/or reprocess the plurality of reports using a plurality of analytics models (230A) to generate an analysis result (235A), for example, for each report and/or each record of interest. In some embodiments, the report data analytics system is configured to use a plurality of logical layers in analyzing the reports. In some cases, each logical layer is configured to use one or more analytics models. For example, the plurality of logical layers include a match-finding layer, an identifier layer, a sequencing layer, a threat-trigger layer, a word conversion layer, a word variation layer, a number filter layer, a leetspeak layer, a phone-words layer, a flagged data layer, and/or the like. In some cases, a user can configure the plurality of logical layers by, for example, selecting certain logical layers, adding one or more logical layers, modifying one or more logic layers, and/or deselecting one or more logical layers. Such user inputs/configurations can be store in a data repository.

In some embodiments, the report data analytics system is configured to evaluate whether a plurality of reports contain data units (e.g., words, numbers, phrases, alphanumerical sequences/values, etc.) matching one or more of the plurality of records of interest using one or more analytics model. In some cases, a match can be an exact match (i.e., a 100% match) or a threshold match (i.e., a match higher than a predetermined threshold) of data in comparison with a target record. In some cases, the match level is determined by character count. In one example, a target record of “investigation,” a finding of the word “investigation” in a report is a match, and a finding of word “investigatin” is also a match for a threshold match with a threshold of 90%, while a finding of word “investigatn” is not a match for a threshold match with a threshold of 90%. In some embodiments, the report data analytics system is configured to evaluate record matching before decoding the reports and after decoding the reports. In some embodiments, the report data analytics system is configured to evaluate and/or label matches after decoding the reports.

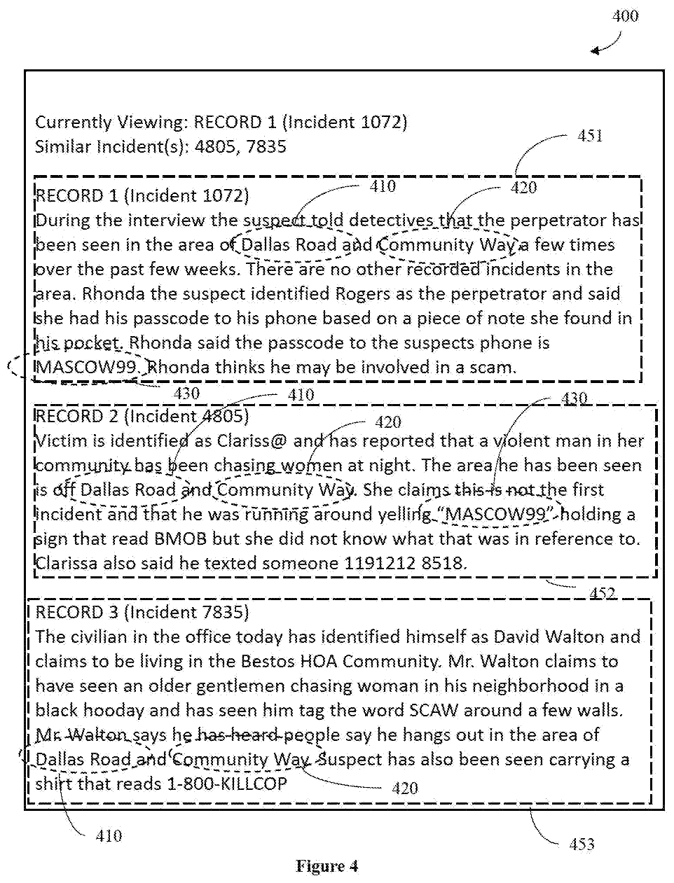

In some cases, the report data analytics system is configured to identify and/or label data units of interest in a respective report using a set of selection criteria. In some embodiments, the selection criteria include at least one of a match criterion and a special data criterion. In some cases, the match criterion requires a match, to a target record at or above a predetermined threshold, for example, an exact match or a threshold match. In some examples, the target record is one of records of interest. In some cases, the special data criterion requires the data unit comprises special data. In some cases, the special data includes, for example, identifiers, trigger words, words mixed with numbers, leetspeak terms, codified words, phone-words, and/or the like. FIG. 4 depicts an illustrative example 400 of reports 451, 452, and 453 having data units of interest. The records of interest include a data unit 410, a data unit 420, and a data unit 430. Using the report data analytics system, the data, unit of interest can be identified, highlighted and/or tagged/labelled in the reports. In this example, the reports 451, 452, and 453 are for different incidents respectively.

In some embodiments, the report data analytics system is configured to process the plurality of reports via a plurality of analytics models to generate an analysis result for each report and/or each record of interest. In some cases, the report data analytics system is configured to process the reports in a plurality of logical layers, where each logical layer may apply one or more analytics models. In some implementations, the analysis result is indicative of finding of the plurality of records of interest. In some cases, at least one analytics model of the plurality of analytics models is configured to evaluate each report in a multidimensional analysis to generate a plurality of analytics scores, each analytics score of the plurality of analytics scores generated for a respective dimension. In one embodiment, the analysis result includes the plurality of analytics scores.

In some cases, the report data analytics system is configured to generate a multidimension analysis result using one or more analytics models. In one embodiment, the report data analytics system is configured to evaluate each report in two dimensions, one is a percentage score and the other is an attention score. In some cases, the percentage score is indicative of matching to the plurality of records of interest in a respective report. In some cases, the attention score is indicative of correlation of the plurality of records of interest in a respective report. In some cases, the percentage score is indicative of the number of identified data units of interest in a respective report. In some cases, the attention score is indicative of identified data units in a respective report.

In some embodiments, the report data analytics system is configured to generate a representation of analytics result (240A). FIG. 5A depicts one illustrative example of a graphical user interface for a report data analytics system. In this example, a graphical representation of the analytics result of a two-dimensional analytics scores for each logical layer is shown. Further in this example, analytics results in the Q4 (the 4^{th} quadrant) can be selected for further analysis and review. FIG. 5B depicts another illustrative example of a graphical user interface for a report data analytics system. In this example, the analytics results of each logical layer are included. In this example, records of interest are highlighted in the analytics results.

FIG. 2B depicts one illustrative flow diagram of a report data analytics system, in accordance with certain embodiments of the present disclosure. Aspects of embodiments of the method 200B may be performed, for example, by components of a report data analytics system (e.g., components of the report data analytics system 100 of FIG. 1A). One or more steps of method 200B are optional and/or can be modified by one or more steps of other embodiments described herein. Additionally, one or more steps of other embodiments described herein may be added to the method 200B. In some embodiments, the report data analytics system receives a plurality of records of interest (210B).

In some embodiments, the plurality of records of interest is a set of predefined codes. In some cases, the plurality of records of interest include a specific data format of interest, for example, the social security number, the date of birth, a driver license number, a vehicle license number, and/or the like. In some cases, the plurality of records of interest is a set of predefined codes stored in a data repository the report data repository 150 of FIG. 1A). In some cases, a user can modify the plurality of records of interest to add user-specified records of interest, select certain records of interest, modify certain records of interest, and/or deselect certain records of interest. In some cases, the user can configure the plurality of records of interest via a graphical user interface to the system. In some cases, the user can configure the plurality of records of interest via system setting. In some cases, a user can configure the plurality of records of interest with inputs received via a software interface (e.g., an application programming interface, a web service, etc.).

In some embodiments, the report analytics processor is configured to receive a plurality of reports (215B). In some cases, the plurality of reports are of a single incident. In some cases, the plurality of reports are of two or more incidents. In some cases, the plurality of reports are selected by one or more criteria, for example, incident location, incident time, and/or the like. In some cases, the report data analytics system may retrieve at least a part of the plurality of reports from a data repository. In some cases, the report data analytics system may receive at least a part of the plurality of reports from another system(s), for example, via a software interface. FIG. 3 depicts illustrative examples of reports 300 in various coding languages. In this example, each report of the reports 300 is of same content but in different coding languages.

In some embodiments, the report data analytics system is configured to decode to one or more of the reports (220B), for example, by decoding the one or more reports using one or more coding languages. The coding languages include, for example, backward coding language, Morse coding language, binary coding language, hexadecimal coding language, leetspeak coding language, hash coding language, shifted coding language, and/or the like. In some cases, the report data analytics system is configured to identify the coding language(s) used in a report and apply the identified coding language(s) to decode the report. In some cases, the report data analytics system is configured to identify the language used in a report and apply a corresponding translation of the identified language to the report. In some cases, the report data analytics system is configured to decode a first report of the plurality of reports based on a first coding language and decode a second report of the plurality of reports based on a second coding language, where the second coding language is different from the first coding language.

In some embodiments, the report data analytics system can apply a natural language processing model to analyze the reports (225B). In some cases, the report data analytics system parses a report into n-grams and generate a plurality of terms based on the n-grams. As used herein, n-gram refers to a contiguous sequence of n words including numbers and symbols from a data stream, which typically is a phrase or a sequence of words with meaning. N-gram can include numbers and symbols, such as a comma, a period a dollar sign, and/or the like. In some cases, the report data analytics system normalizes the parsed n-grams. Further, in some cases, the report data analytics system generates a plurality of normalized sections having normalized terms based on the n-grams. In one example, the plurality of intake terms include normalized n-grams. As one example, the n-grams is a date and the normalized term is the date in a predefined format (e.g., year-month-date). In some cases, the report data analytics system determines contexts of the normalized terms. In one example, the contexts are a part of a same sentence of the normalized terms. In one example, the natural language system parses the n-grams and labels the n-grams based on the contexts, for example, period, expense, revenue, etc. In some embodiments, a report data analytics system uses a natural language model for processing the document and parsed n-grams. For example, a natural language model can be a statistical language model, a neural network language model, and/or the like.

In some embodiments, the report data analytics system is configured to process the plurality of reports using one or more of the logical layers (e.g., layers 230B-248B) implementing a plurality of analytics models to generate an analysis result (250B), for example, for each report and/or each record of interest. In some embodiments, the report data analytics system is configured to use a plurality of logical layers in analyzing the reports. In some cases, each logical layer is configured to use one or more analytics models. For example, the plurality of logical layers include a match-finding layer 230B, an identifier layer 232B, a sequencing layer 234B, a threat-trigger layer 236B, a word conversion layer 238B, a word variation layer 240B, a number filter layer 242B, a leetspeak layer 244B, a phone-words layer 246B, a flagged data layer 248B, and/or the like. In some cases, a user can configure the plurality of logical layers by, for example, selecting certain logical layers, adding one or more logical layers, modifying one or more logic layers, and/or deselecting one or more logical layers. Such user inputs/configurations can be store in a data repository (e.g., the report data repository 150 in FIG. 1A). In some embodiments, the report data analytics system is configured to process reports using a part of or all of the logical layers 230B-248B. In some embodiments, the report data analytics system is configured to process reports using a part of or all of the logical layers 230B-248B and some other logical layers.

In some embodiments, the report data analytics system is configured to evaluate whether a plurality of reports contain data units (e.g., words, numbers, phrases, alphanumerical sequences/values, etc.) matching one or more of the plurality of records of interest using one or more analytics model. In some cases, a match can be an exact match (i.e., a 100% match) or a threshold match (i.e., a match higher than a predetermined threshold) of data in comparison with a target record. In some cases, the match level is determined by character count. In one example, for a target record of “investigation,” a finding of the word “investigation” in a report is a match, and a finding of word “investigatin” is also a match for a threshold match with a threshold of 90%, while a finding of word “investigatn” is not a match for a threshold match with a threshold of 90%. In some embodiments, the report data analytics system is configured to evaluate record matching before decoding the reports and after decoding the reports. In some embodiments, the report data analytics system is configured to evaluate and/or label matches after decoding the reports.

In some cases, the report data analytics system is configured to identify and or label data units of interest in a respective report using a set of selection criteria. In some embodiments, the set of selection criteria include at least one of a match criterion and a special data criterion. In some cases, the match criterion requires a match to a target record at or above a predetermined threshold, for example, an exact match or a threshold match to the target record. In some examples, the target record is one of records of interest. In some embodiments, the target record is a selected record. In some cases, the special data criterion requires that the data unit comprises special data. In some eases, the special data includes, for example, identifiers, trigger words, words mixed with numbers, leetspeak terms, codified words, phone-words, and/or the like. FIG. 4 depicts an illustrative example 400 of reports 451, 452, and 453 having data units of interest. The data units of interest include a data unit 410, a data unit 420, and a data unit 430. Using the report data analytics system, the data units of interest can be identified, highlighted and/or tagged/labelled in the reports. In this example, the reports 451, 452, and 453 are for different incidents respectively.

In some embodiments, the analysis result is indicative of finding of the plurality of records of interest in reports. In some implementations, the analysis result is indicative of finding of the plurality of data units of interest in reports. In some cases, at least one analytics model of the plurality of analytics models is configured to evaluate each report in a multidimensional analysis to generate a plurality of analytics scores, each analytics score of the plurality of analytics scores generated for a respective dimension. In one embodiment, the analysis result includes the plurality of analytics scores.

In some cases, the report data analytics system is configured to generate a multidimension analysis result using one or more analytics models. In one embodiment, the report data analytics system is configured to evaluate each report in two dimensions, one is a percentage score and the other is an attention score. In some eases, the percentage score is indicative of matching to the plurality of records of interest in a respective report. In some cases, the attention score is indicative of correlation of the plurality of records of interest in a respective report. In some cases, the percentage score is indicative of the number of identified data units of interest in a respective report. In some cases, the attention score is indicative of identified data units in a respective report. FIG. 5A depicts one illustrative example of an analytics result in percentage scores and attention scores. In this example, each logical layer has a percentage score and an attention score. Further in this example, analytics results in the Q4 (the 4^{th} quadrant) can be selected for further analysis and review, such that L2 and L9 layers should be evaluated and/or reviewed further. In some cases, this method is used to filter reports requesting further review.

In some embodiments, the report data analytics system is configured to use the match-finding layer 230B to evaluate a report related to records of interests, for example, how many records of interests are found in the report, what are the match level (e.g., 60%, 100%) of a match to a record of interest. The match-finding layer 230B can use any embodiments of analytics models described herein. In some embodiments, the match level can be determined using character count. In one embodiment, the match-finding layer 230B is configured to evaluate each report in two dimensions, one is a percentage score and the other is an attention score. In some embodiments, the match-finding layer 230B is configured to evaluate each report from three dimensions—a threshold percentage score, a content percentage score, and an attention score. In some cases, the report data analytics system is configured to use the match-finding layer 230B to identify and/or label data units, each is an exact match or a threshold match to a record of interest, and to determine a threshold percentage score. In some cases, the match-finding layer 230B is configured to determine a threshold percentage score based on the number of characters in the identified data units of interest. In one example, the match-finding layer 230B is configured to take the number of character count in the identified data units of interest and divides it by the total number of characters available in the report data and multiplies it by 100 to yield the threshold percentage score.

In some embodiments, the match-finding layer 230B is configured to determine a content percentage score based on the number of characters in the identified data units that are exact matches to a respective record of interest, also referred to as matching data units. In one example, the match-finding layer 230B is configured to take the number of character count in the matching data units and divides it by the total number of characters available in the report data and multiplies it by 100 to yield the content percentage score. In some embodiments, the match-finding layer 230B is configured to determine an attention score by assigning each identified data unit of interest with a point value. In one example, each identified matching data unit in the report is assigned to a first point value (e.g., 2 points). Each identified data unit of interest that is not a matching data unit is assigned to a second point value (e.g., 1 point). In one example, if the report has two (2) matching data units of interest and one (1) other data unit of interest, the report is assigned with an attention score of 5. In another example, the match-finding layer 230B can evaluate across all reports or all selected reports to determine an overall attention score. In some cases, the match-finding layer 230B is configured to filter pertinent reports for the user using the evaluation in two or more dimensions. In one example, each pertinent report has a score higher than a respective predetermined threshold in each dimension of the two or more dimensions (e.g., the predetermined threshold for the percentage score dimension is 60%, the predetermined threshold for the attention score dimension is 5).

In some embodiments, the report data analytics system is configured to use the identifier layer 232B to identify records in a report that match identifiers and/or label such identifiers, for example, using an identifier model. In some designs, the identifier model includes a set of identifier criteria. In some cases, the user can set the identifier criteria and/or parameters in the identifier criteria. In some cases, the identifier layer 232B is configured to store default identifier criteria in data repository (e.g., the report data repository 150 in FIG. 1A). One example of a default identifier is a data format for a social security number. One example of a user specified identifier is a data format for a driver license of a state. In one embodiment, an identifier can include various formats of the identifier. In the example of phone number identifier, the identifier can include a format of 10 digits (e.g., “xxxxxxxxxx”), with area code in parenthesis (e.g., “(xxx) xxx-xxxx”), and with dashes (e.g., “xxx-xxx-xxxx”), where each format can be set to an identifier criterion. In some embodiments, the identifier model is configured to identify and/or label identifiers (i.e., data units of interest) using the identifier criteria.

The identifier layer 232B can use any embodiments of analytics models described herein. In some embodiments, the identifier layer 232B is configured to evaluate a report in a multidimensional analysis to generate a plurality of analytics scores, each analytics score of the plurality of analytics scores generated for a respective dimension. In some cases, the identifier layer 232B is configured to analyze a report from two dimensions—a dimension of a percentage score and a dimension of an attention score. In some embodiments, the identifier layer 232B is configured to determine a percentage score based on the number of data units of interest identified in the report. In one embodiment, the identifier layer 232B is configured to determine a percentage score as the number of data units of interest identified in the report and is divided by the total number of words in the report multiplied by 100 to yield the percentage score.

In some embodiments, the identifier layer 232B is configured to determine an attention score by assigning each identified identifiers (i.e., data units of interest) in the report data with a point value (e.g., 1 point). In some embodiments, the report has an overall attention score assigned by the identifier layer 232B based, on the number of identifiers identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the sequencing layer 234B to process a report with unscrambled records of interest, e.g., each record of interest in various orders with selected alphanumeric values from the record of interest, using a sequencing model. In some cases, the order can be, for example, a reversed order, a random order, a circular shift, and/or the like. For example, a target record of “major” can have 2 unscrambled five-letter words, 2 unscrambled four-letter words, 12 unscrambled three letter words, and 7 unscrambled two-letter words. In some cases, the sequencing model is configured to create every possible combination of letters in a record of interest to generate words in various letter orders. It then compares word or data unit in a report with the unscrambled records of interest to evaluate if there are any matches or any threshold matches, including matches of a predetermined threshold or a user defined threshold (e.g., 90% match). In a match is found, the matched data unit is labelled/tagged as a data unit of interest.

In some embodiments, the sequencing layer 234B is configured to evaluate a report related to unscrambled records of interests, for example, to identify data units of interest, where each is a match (e.g., an exact match or a threshold match) to a respective unscrambled record of interest. The sequencing layer 234B can use any embodiments of analytics models described herein. In some embodiments, the sequencing layer 234B is configured to evaluate a report in a multidimensional analysis to generate a plurality of analytics scores, each analytics score of the plurality of analytics scores generated for a respective dimension. In some cases, the sequencing layer 234B is configured to analyze a report from two dimensions—a dimension of a percentage score and a dimension of an attention score. In some embodiments, the sequencing layer 234B is configured to determine a percentage score based on the number of data units of interest identified in the report. In one embodiment, the sequencing layer 234B is configured to determine a percentage score as the number of data units of interest identified in the report and is divided by the total number of words in the report multiplied by 100 to yield the percentage score.

In some embodiments, the sequencing layer 234B is configured to determine an attention score by assigning each identified unscrambled record of interest (i.e., data units of interest) in the report data with a point value (e.g., 1 point). In some embodiments, the report has an overall attention score assigned by the sequencing layer 234B based on the number of unscrambled records of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the threat-trigger layer 236B to identify trigger words using a trigger word model. In some embodiments, the trigger words can be retrieved from a data repository (e.g., the report data repository 150 of FIG. 1A). In some embodiments, the trigger words can be added modified, selected, and/or deselected by a user. One example of a trigger word is “shoot.” In some cases, the threat-trigger layer 236B is configured to compare every word in a report with the trigger words to identify any matches or threshold matches. In some cases, the sequencing layer 236B is configured to compare data units in a report with the trigger words. In various letter orders to identify any matches or threshold matches. In a match is found, the matched data unit is labelled as a data unit of interest. The threat-trigger layer 236B can use any embodiments of analytics models described herein.

In some embodiments, the threat-trigger layer 236B is configured to is configured to evaluate a report in a multidimensional analysis to generate a plurality of analytics scores, each analytics score of the plurality of analytics scores generated for a respective dimension. In some cases, the threat-trigger layer 236B configured to analyze a report from two dimensions—a dimension of a percentage score and a dimension of an attention score. In some embodiments, the threat-trigger layer 236B is configured to determine a percentage score based on the number of data units of interest identified in the report. In one embodiment, the threat-trigger layer 236B is configured to determine a percentage score as the number of data units of interest identified in the report and is divided by the total number of words in the report multiplied by 100 to yield the percentage score.

In some embodiments, the threat-trigger layer 236B is configured to determine an attention score by assigning each identified trigger words (i.e., data units of interest) in the report data with a point value (e.g., 1 point). In some embodiments, the report has an overall attention score assigned by the threat-trigger layer 236B based on the number of trigger words identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the word conversion layer 238B to evaluate a report using a word conversion model. In some embodiment, the word conversion model is configured to generate converted records of interest by convening records of interest into numbers and/or alphanumerical values in various orders. In some cases, the order can be, for example, an unchanged order (e.g., direct conversion from letter to number), a reversed order, a random order, a circular shift, and/or the like. In one example, a record of interest “BOMB” has converted records of interest as “215132”, “231512”, “251312”, etc. In some cases, the word conversion layer 238B is configured to scan a report to identify any matches or threshold matches to the converted records of interest. In some cases, the word conversion layer 238B is configured to compare data units in a report with the word-converted records of interest to identify any matches or threshold matches. In a match is found, the matched data unit is labelled as a data unit of interest.

The word conversion layer 238B can use any embodiments of analytics models described herein. In some embodiments, the word conversion layer 238B is configured to evaluate a report in a multidimensional analysis to generate a plurality of analytics scores, each analytics score of the plurality of analytics scores generated for a respective dimension. In some cases, the word conversion layer 238B is configured to analyze a report from two dimensions—a dimension of a percentage score and a dimension of an attention score. In some embodiments, the word conversion layer 238B is configured to determine a percentage score based on the number of data units of interest identified in the report. In one embodiment, the word conversion layer 238B is configured to determine a percentage score as the number of data units of interest identified in the report and is divided by the total number of words in the report multiplied by 100 to yield the percentage score.

In some embodiments, the word conversion layer 238B is configured to determine an attention score by assigning each identified data unit of interest (i.e., data units of interest) in the report data with a point value (e.g., 1 point). In some embodiments, the report has an overall attention score assigned by the word conversion layer 238B based on the number of data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the word variation layer 240B to evaluate a report using a word variation model to identify variations (e.g., a slang term) of records of interest, also referred to as variated records of interest. In one example, the word “because” has the variations of “cus”, “cuz”, and “be”. In some cases, the word-variation layer 240B is configured to scan a report to identify any matches or threshold matches to the variated records of interest. In some cases, the word variation layer 240B is configured to compare data units in a report with variated records of interest to identify any matches or threshold matches. In a match is found, the matched data unit is labelled/tagged as a data unit of interest.

The word variation layer 240B can use any embodiments of analytics models described herein. In some embodiments, the word variation layer 240B is configured to evaluate a report in a multidimensional analysis to generate a plurality of analytics scores, each analytics score of the plurality of analytics scores generated for a respective dimension. In some cases, the word variation layer 240B is configured to analyze a report from two dimensions—a dimension of a percentage score and a dimension of an attention score. In some embodiments, the word variation layer 240B is configured to determine a percentage score based on the number of data units of interest identified in the report. In one embodiment, the word variation layer 240B is configured to determine a percentage score as the number of data units of interest identified in the report and is divided by the total number of words in the report multiplied by 100 to yield the percentage score.

In some embodiments, the word variation layer 240B is configured to determine an attention score by assigning each identified data unit of interest (i.e., data units of interest) in the report data with a point value (e.g., 1 point). In some embodiments, the report has an overall attention score assigned by the word variation layer 240B based on the number of data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the number filter layer 242B to evaluate a report by identifying data units having numbers mixed with alphanumeric characters in the reports, which is referred to as word-with-number, for example, using a numbering model. In some cases, the numbering model is configured to remove numbers mixed with alphabetical characters. For example, a numbering model is configured to covert “fil2ter” to “filter”. In some embodiments, the number filter layer 242B is configured to identify and/or label each data unit in the report that is a word-with-number, each word-with-number being a data unit of interest. In some embodiments, the number filter layer 242B is configured to evaluate a report related to the words-with-numbers in the report, for example, how many words-with-numbers are found in the report. In one embodiment, the number filter layer 242B is configured to evaluate each report in two dimensions, one is a percentage score and the other is an attention score.

In some embodiments, the number filter layer 242B is configured to determine a percentage score based on the number of removed numbers from the report. In some embodiments, the number filter layer 242B is configured to determine a percentage score based on the number of word-with-number data units identified in the report. In one embodiment, the number filter layer 242B is configured to determine a percentage score as the number of removed numbers from the report and is divided by the total number of characters in the report multiplied by 100 to yield the percentage.

In some embodiments, the number filter layer 242B is configured to determine an attention score by assigning each identified word-with number data unit in the report data with a point value (e.g., 1 point). In some embodiments, the report has an overall attention score assigned by the number filter layer 242B based on the number of word-with-number identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the leetspeak layer 244B to evaluate a report by identifying data units having leetspeaks in the reports using a leetspeak model. As one example, a leetspeak data unit (i.e., a data unit of interest) has the letter “a” replaced by the symbol “@”. As another example, a leetspeak data unit has the letter “e” replaced by the number “3”. In some embodiments, the leetspeak layer 244B is configured to identify and/or label leetspeak data units in the report. In some embodiments, the leetspeak layer 244B is configured to identify and/or label leetspeak data units that are matches or threshold matches to leetspeak-version records of interest in the report. In some cases, the leetspeak model is configured to covert the leetspeak data unit to a regular word. For example, a leetspeak model is configured to covert “filt3r” to “filter”. In some embodiments, the leetspeak layer 244B is configured to evaluate a report related to leetspeak words and/or leetspeak-version records of interest in the report, for example, how many leetspeak words are found in the report, how many leetspeak-version records of interest in the report. In one embodiment, the leetspeak layer 244B is configured to evaluate each report in two dimensions, one is a percentage score and the other is an attention score.

In some embodiments, the leetspeak layer 244B is configured to determine a percentage score based on the number of the identified leetspeak data units (e.g., data units having leetspeak matching leetspeak-version records of interest) in the report. In some embodiments, the leetspeak layer 244B is configured to determine a percentage score based on the number of the identified leetspeak data units in the report. In one embodiment, the leetspeak layer 244B is configured to determine a percentage score as the number of identified leetspeak data units in the report and is divided by the total number of words in the report multiplied by 100 to yield the percentage score.

In some embodiments, the leetspeak layer 244B is configured to determine an attention score by assigning each identified leetspeak data units in the report data with a point value (e.g., 1 point). In some embodiments, the report has an overall attention score assigned by the leetspeak layer 244B based on the number of the identified leetspeak data units in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the phone-words layer 246B to evaluate a report by identifying mnemonic phrases in the report, for example, by a phone-word model. In one example, a phone word is a data unit replacing the number “2” by alphabetical letter “A”, “B”, or “C”. In some embodiments, the phone-words layer 246B is configured to identify and/or label data units as phone-word data units of interest in the report that are phone-words. In one embodiment, a phone-word is a data unit matching certain identifier format after replacing alphabetical characters with corresponding numbers. In some embodiments, the phone-words layer 246B is configured to identify and/or label data units as phone-word data units of interest in the report that are matches or threshold matches to phone-word-version records of interest. In some cases, the phone-words model is configured to covert the phone-words data unit to a regular identifier. For example, a phone-word model is configured to covert “1-800-ABC-DEFG” to “1-800-222-3334”. In some embodiments, the phone-words layer 246B is configured to evaluate a report related to the identified phone-word data units in the report, for example, how many phone-words phrases are found in the report, how many phone-words-version records of interest in the report. In one embodiment, the phone-words layer 246B is configured to evaluate each report in two dimensions, one is a percentage score and the other is an attention score.

In some embodiments, the phone-words layer 246B is configured to determine a percentage score based on the number of phone-word data units of interest identified in the report. In some embodiments, the phone-words layer 246B is configured to determine a percentage score based on the number of phone-word data units of interest identified in the report. In one embodiment, the phone-words layer 246B is configured to determine a percentage score as the number of phone-word data units of records of interest identified in the report and is divided by the total number of words in the report multiplied by 100 to yield the percentage score.

In some embodiments, the phone-words layer 246B is configured to determine an attention score by assigning each identified phone-word data units of interest in the report data with a point value (e.g., 1 point). In some embodiments, the report has an overall attention score assigned by the phone-words layer 246B based on the number of phone-word data units of interest identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to use the flagged data, layer 248B to evaluate a report based on data flagged by a user (e.g., by a user manually, by a system, etc.). In one embodiment, each flagged data has a data structure including data value and flagging context. The flagging context can include an explanation of why the data is flagged and/or context of the flagged data in a respective report. In one example, at least a part of or all of the flagged data is flagged by a user manually. In one example, at least a part of or all of the flagged data is received from another system. In some cases, the flagged data layer 248B is configured to identify and/or label the flagged data. In some embodiments, the flagged data layer 248B is configured to evaluate a report related to the flagged data in the report, for example, how many flagged data are found in the report. In one embodiment, the flagged data layer 248B is configured to evaluate each report in two dimensions, one is a percentage score and the other is an attention score.

In some embodiments, the flagged data layer 248B is configured to determine a percentage score based on the number of flagged data identified in the report. In some embodiments, the flagged data layer 248B is configured to determine a percentage score based on the number of flagged data and/or the number of characters in the flagged data identified in the report. In one embodiment, the flagged data layer 248B is configured to determine a percentage score as the number of identified flagged data and is divided by the total number of words in the report multiplied by 100 to yield the percentage score. In one embodiment, the flagged data layer 248B is configured to determine a percentage score as the number of characters in identified flagged data and is divided by the total number of words in the report multiplied by 100 to yield the percentage score.

In some embodiments, the flagged data layer 248B is configured to determine an attention score by assigning each identified flagged data in the report data with a point value (e.g., 1 point). In some embodiments, the report has an overall attention score assigned by the flagged data layer 248B based on the number of flagged data identified in the report. In one embodiment, the overall attention score is a summation of the assigned point values to the report. In one embodiment, the overall attention score is a normalized summation of the assigned point values to the report. In one example, the normalized summation is assigned between a high attention score and a low attention score.

In some embodiments, the report data analytics system is configured to generate a representation of the analytics result (255B). FIG. 5A depicts one illustrative example of a graphical user interface for a report data analytics system. In this example, a graphical representation of the analytics result of a two-dimensional analytics scores for each logical layer is shown, where the two-dimensional analytics scores includes percentage scores and attention scores. In this example, each logical layer has a percentage score and an attention score. In some embodiments, the percentage score is indicative of an overall relevancy of the number of records of interest (e.g., character match) identified in the report. In some embodiments, the attention score is indicative of relevancy of records of interest (e.g., record match) identified in the report. Further in this example, analytics results in the Q4 (the 4^{th} quadrant) can be selected for further analysis and review, such that L2 and L9 layers should be evaluated and/or reviewed further. In some cases, this method is used to filter reports requesting additional review and analysis. FIG. 5B depicts another illustrative example of a graphical user interface for a report data analytics system. In this example, the analytics results of each logical layer are included. In some cases, records of interest are highlighted in the analytics results.

Various modifications and alterations of the disclosed embodiments will be apparent to those skilled in the art. The embodiments described are only illustrative examples. The features of one disclosed example can also be applied to all other disclosed examples unless otherwise indicated. It should also be understood that all U.S. patents, patent application publications, and other patent and non-patent documents referred to herein are incorporated by reference, to the extent they do not contradict the foregoing disclosure.

What is claimed is:

1. A method implemented by a computer system having one or more processors and memories, comprising:
receiving a plurality of reports, each report of the plurality of reports comprising a data stream;
receiving a plurality of records of interest; and
processing the plurality of reports using a plurality of analytics models to generate an analysis result for each report, the analysis result for each report indicative of finding the plurality of records of interest in a respective report;
wherein at least one analytics model of the plurality of analytics models is configured to evaluate each report in a multidimensional analysis to generate a plurality of analytics scores, each analytics score of the plurality of analytics scores generated for a respective dimension.

2. The method of claim 1, wherein the plurality of analytics scores comprise a percentage score indicative of matching to the plurality of records of interest in a respective report.

3. The method of claim 1, wherein the plurality of analytics scores comprise an attention score indicative of correlations of the plurality of records of interest in a respective report.

4. The method of claim 1, wherein the analysis result for a perspective report comprises a graphical representation of the multidimensional analysis.

5. The method of claim 1, wherein at least one analytics model of the plurality of analytics models is a rule-based model.

6. The method of claim 1, further comprising:
decoding at least one report of the plurality of reports based on a coding language.

7. The method of claim 1, further comprising:
decoding at least one report of the plurality of reports based on a coding language; and
re-processing the at least one decoded report via the plurality of analytics models to generate an updated analysis result for the at least one report.

8. The method of claim 1, further comprising:
decoding a first report of the plurality of reports based on a first coding language; and
decoding a second report of the plurality of reports based on a second coding language, the second encoding language different from the first encoding language.

9. The method of claim 1, herein the plural of analytics models comprise a natural language processing model.

10. The method of claim 1, wherein the plurality of analytics models comprise a machine learning model, the machine learning model being trained by a plurality of historical report and associated analytics results.

11. The method of claim 1, further comprising:
receiving an input from a user.

12. The method of claim 11, wherein at least one of the plurality of analytics models comprises a rule, and wherein the rule modified lased on the input.

13. The method of claim 11, wherein the input comprises a format of data, wherein at least one of the plurality of analytics models comprises a rule related to a data format, and wherein the rule is modified based on the input.

14. The method of claim 11, wherein the input comprises information related to one or more coding languages.

15. The method of claim 1, wherein processing the plurality of reports comprises procession the plurality of reports using a plurality of logical layers, and wherein each logical layer of the plurality of logical layers is configured to apply one or more of the plurality of analytics models.

16. The method of 15, further comprising:
receiving an input from a user;
wherein the input comprises a configuration of the plurality of logical layers;
wherein the configuration comprises at least one of an addition of a logical layer, a modification of a logical layer, a selection of a logical layer and a deselection of a logical layer.

17. The method of claim 1, further comprising:
identifying one or more data units in a respective report using a set of selection criteria;
wherein the set of selection criteria comprises at least one of a match criterion and a special data criterion;
wherein the match criterion requires a match to a target record at a match level at or above a predetermined threshold; and
wherein the special data criterion requires the data unit comprises special data.

18. The method of claim 17, wherein the match level is a number of characters matching the target record and a number of characters in the target record.

19. The method of claim 17, wherein the plurality of analytics scores comprise a percentage score indicative of a number of identified data units in a respective report.

20. The method of claim 17, wherein the plurality of analytics scores comprise an attention score indicative of identified data units in a respective report.

21. A computer-implemented system comprising:
one or more memories having instructions stored thereon;
one or more processors configured to execute the instructions to perform operations comprising:
receiving a plurality of reports, each report of the plurality of reports comprising a data stream;
receiving a plurality of records of interest; and
processing the plurality of reports using a plurality of analytics models to generate an analysis result for each report, the analysis result for each report indicative of finding the plurality of records of interest in a respective report;
wherein at least one analytics model of the plurality of analytics models is configured to evaluate each report in a multidimensional analysis to generate a plurality of analytics scores, each analytics score of the plurality of analytics scores generated for a respective dimension.

22. The system of claim 21, wherein the plurality of analytics scores comprise a percentage score indicative of matching to the plurality of records of interest in a respective report.

23. The system of claim 21, wherein the plurality of analytics scores comprise an attention score indicative of correlation of the plurality of records of interest in a respective report

24. The system of claim 21, wherein the analysis result for a perspective report comprises a graphical representation of the multidimensional analysis.

25. The system of claim 21, wherein at least one analytics model of the plurality of analytics models is a rule-based model.

26. The system of claim 21, wherein the operations further comprise:
decoding at least one report of the plurality of reports based on a coding language.

27. The system of claim 21, wherein the operations further comprise:
decoding at least one report of the plurality of reports based on a coding language; and
re-processing the at least one decoded report via the plurality of analytics models to generate an updated analysis result for the at least one report.

28. The system of claim 21, wherein the operations further comprise:
decoding a first report of the plurality of reports based on first coding language; and
decoding a second report of the plurality of reports based on a second coding language, the second encoding language different from the first encoding language.

29. The system of claim wherein the plurality of analytics models comprise a natural language processing model.

30. The system of claim 21, wherein the plurality of analytics models comprise a machine learning model, the machine learning model being trained by a plurality of historical report and associated analytics results.

31. The system of claim 21, wherein the operations further comprise:
receiving an input from a user.

32. The system of claim 31, wherein at least one of the plurality of analytics models comprises a rule, and wherein the rule is modified based on the input.

31. The system of claim 31, wherein the input comprises a format of data, wherein at least one of the plurality of analytics models comprises a rule related to a data format, and wherein the rule is modified based on the input.

34. The system of claim 31, wherein the input comprises information related to one or more coding languages.

35. The system of claim 21, wherein processing the plurality of reports comprises processing the plurality of reports using a plurality of logical layers, and wherein each logical layer of the plurality of logical layers is configured to apply one or more of the plurality of analytics models.

36. The system of claim 35, wherein the operations further comprise:
receiving an input from a user;
wherein the input comprises a configuration of the plurality of logical layers;
wherein the configuration comprises at least one of an addition of a logical layer, a modification of a logical layer, a selection of a logical layer and a deselection of a logical layer.

37. The system of claim 21, wherein the operations further comprise:
identifying one or more data units in a respective report using a set of selection criteria;
wherein the set of selection criteria comprises at least one of a match criterion and a special data criterion;
wherein the match criterion requires a match to a target record at a match level at or above a predetermined threshold; and
wherein the special data criterion requires the data unit comprises special data.

38. The system of claim 37, wherein the match level is a number of characters matching the target record and a number of characters in the target record.

39. The system of claim 37, wherein the plurality of analytics scores comprise a percentage score indicative of a number of identified data units in a respective report.

40. The system of claim 37, wherein the plurality of analytics scores comprise an attention score indicative of identified data units in a respective report.
